(19) United States
(12) Patent Application Publication
(10) Pub. No.: US 2009/0185067 A1
(43) Pub. Date: Jul. 23, 2009

(54) COMPACT AUTOMATIC FOCUSING CAMERA

(75) Inventors: Gyoung Il Cho, Seoul (KR); Cheong Soo Seo, Seongnam (KR)

Correspondence Address: STEREO DISPLAY INC., 980 EAST ORANGETHORPE AVENUE, SUITE F, ANAHEIM, CA, 92801, US

(73) Assignees: STEREO DISPLAY, INC., Anaheim, CA (US); ANGSTROM, INC., Seongnam (KR)

(21) Appl. No.: 11/963,647

(22) Filed: Dec. 21, 2007

(51) Int. Cl. H04N 5/232; G02B 26/00; G03B 13/32

(52) U.S. Cl. 348/345; 359/291; 348/E05.042

(57) ABSTRACT

The present invention provides a compact automatic focusing system using a Micro-Electro-Mechanical System (MEMS) unit. The automatic focusing system using the MEMS unit has a small volume and low power consumption, and its operation is very reliable, precise, and fast. The MEMS unit for automatic focusing comprises at least one micromirror, at least one micro-actuator, and at least one micro-converter fabricated on the same substrate by microfabrication technology. By fabricating the micromirror, the micro-actuator, the micro-converter on the same substrate, the volume of the automatic focusing system of the present invention can be greatly reduced. The micro-converter converts the in-plane translation of the micro-actuator to out-of-plane translation of the micromirror to provide a large out-of-plane translation range.

### FIELD OF INVENTION

The present invention relates to an automatic focusing device, more particularly, to an automatic focusing device using micro-electro-mechanical system providing compactness, reliability, low power consumption, and fast focusing.

### BACKGROUND OF THE INVENTION

The invention contrives to provide a reliable compact and slim automatic focusing camera with low power consumption and fast focusing capability for portable devices such as cellular phone camera.

Most conventional automatic focusing systems perform their automatic focusing by moving one or more lenses using an electro-magnetically driven motor and/or piezo-electrically actuated apparatus. Since the lens or lenses in those systems have a considerable inertia and need to have macroscopic mechanical motions, the automatic focusing systems require a macroscopic actuator generating large actuating force. The macroscopic actuator can cause many problems including bulky size, large power consumption, slow focusing time, and eventually decrease in the probability of the automatic focusing system. The automatic focusing can be performed by moving a sensor, as well. But, it also requires a macroscopic actuator with additional complexity necessary to satisfy electrical connection. For simpler automatic focusing, a movable mirror can be used for the automatic focusing systems. The movable mirror can provide a simple and reliable automatic focusing, but it still requires a macroscopic actuator.

To apply the automatic focusing system to portable devices such as cellular phone camera, it is very important to reduce volume and power consumption of the automatic focusing system and increase the reliability and focusing speed of automatic focusing function.

### SUMMARY OF THE INVENTION

The present invention contrives to reduce the volume and the power consumption and increase the reliability and focusing speed of an automatic focusing system. FIG. 1 shows a conventional automatic focusing system using a mirror translation. An actuator is connected to the mirror such that the mirror moves to adjust focusing. Since the optical system with automatic focusing function requires additional optical components including a mirror and an actuator, the optical system has larger volume than an optical system without automatic focusing function. To apply automatic focusing system to portable devices such as cellular phone camera, it is very important to reduce the volume and power consumption of the automatic focusing system and increase the reliability and focusing speed of automatic focusing function.

In the present invention, the automatic focusing function is performed by a Micro-Electro-Mechanical System (MEMS) unit. The MEMS unit has a small volume and low power consumption, and its operation is very reliable, precise, and fast. The MEMS unit for automatic focusing includes at least one micromirror and at least one micro-actuator fabricated on the same substrate by microfabrication technology. By fabricating the micromirror and the micro-actuator on the same substrate, the volume of the automatic focusing system of the present invention can be greatly reduced. In general, an actuator used for automatic focusing is required to provide several hundreds micrometer of out-of-plane translation to a mirror. The out-of-plane translation is defined as a translation in the surface normal direction of the substrate while the in-plane translation is defined as a translation in the direction of an axis laying on the substrate surface. The conventional MEMS devices are capable of providing out-of-plane translation to the mirror and have an advantage of adding negligible volume to the optical system. However, they have a limited range in the out-of-plane translation; typically only several micrometers. In order to increase the range of the out-of-plane translation, the present invention preferably comprises at least one micromirror, at least one micro-actuator, and at least one micro-converter, wherein the micro-converter converts the in-plane translation of the micro-actuator to out-of-plane translation of the micromirror. The conventional MEMS device has a larger range in the in-plane translation than in the out-of-plane translation. The micro-converter of the present invention allows large out-of-plane translation by converting the large in-plane translation of the micro-actuator into the large out-of-plane translation of the micromirror. Preferably, the micro-actuator is actuated by electrostatic force. The micro-actuator can be a least one comb-drive using electrostatic force. The comb-drive can generate “coming and going” in-plane motion with a short stroke. The combination of two comb-drives can be used as a micro-actuator, wherein two comb-drives generate in-plane revolution and the in-plane revolution is converted to large linear in-plane translation. Then, the large linear in-plane translation can be converted to the large out-of-plane translation by the micro-converter. The micro-converter comprises at least one beam and at least one hinge. All structures in the MEMS unit including the micromirror, micro-actuator, and the micro-converter can be fabricated on the same substrate by microfabrication technology and the micro-actuator can be controlled by applied voltage.

The general principle, structure and methods for making the discrete motion control of MEMS device are disclosed in U.S. patent applicaton Ser. No. 10/872,241 filed Jun. 18, 2004, U.S. patent applicaton Ser. No. 11/072,597 filed Mar. 4, 2005, U.S. patent application Ser. No. 11/347,590 filed Feb. 4, 2006, U.S. patent applicaton Ser. No. 11/369,797 filed Mar. 6, 2006, U.S. patent application Ser. No. 11/426,565 filed Jun. 26, 2006, U.S. patent applicaton Ser. No. 11/463,875 filed Aug. 10, 2006, U.S. patent applicaton Ser. No. 11/534,613 filed Sep. 22, 2006, U.S. patent application Ser. No. 11/534,620 filed Sep. 22, 2006, U.S. patent applicaton Ser. No. 11/549,954 filed Oct. 16, 2006, U.S. patent application Ser. No. 11/609,882 filed Dec. 12, 2006, U.S. patent applicaton Ser. No. 11/685,119 filed Mar. 12, 2007, U.S. patent applicaton Ser. No. 11/693,698 filed Mar. 29, 2007, U.S. patent application Ser. No. 11/742,510 filed Apr. 30, 2007, and U.S. patent applicaton Ser. No. 11/762,683 filed Jun. 13, 2007, all of which are incorporated herein by references.

The portable optical devices have a high demand to provide high quality images while maintaining compactness. When the automatic focusing system uses a single mirror having a large area size, distortion and twisting problems of the mirror can occur, which causes aberration. The present invention provides more robust and reliable automatic focusing system using a plurality of micromirrors. The MEMS unit of the present invention uses a plurality of micromirrors, a plurality of micro-actuators, and a plurality of micro-converters. The micromirrors are configured to have large out-of-plane translations. The micro-actuators are configured to have in-plane motions and make the micromirrors have out-of-plane motions. The micro-converters are configured to provide large out-of-plane motions to the micromirrors by converting the in-plane translations of the micro-actuators into the out-of-plane translations of the micromirrors. The micromirrors, the micro-actuators, and the micro-converters are fabricated on the same substrate by microfabrication technology. A plurality of comb-drives using electrostatic force can be used as in-plane micro-actuators.

An automatic focusing system as one embodiment of the present invention using an MEMS unit comprises a lens unit, an image sensor, and an MEMS unit. The MEMS unit comprises a plurality of micromirrors having reflective surfaces and configured to have out-of-plane translations, a plurality of micro-actuators configured to have in-plane translations, a plurality of micro-converters configured to convert the in-plane translations of the micro-actuators to the out-of-plane translations of the micromirrors, and a substrate having a control circuitry and supporting the micromirrors, the micro-actuators, and micro-converters. The MEMS unit is positioned between the lens unit and the image sensor and configured to automatically focus an image received from the lens unit to the image sensor by adjusting the out-of-plane translations of the micromirrors. The out-of-plane translations of the micromirrors are adjusted by the control circuitry controlling the in-plane translations of the micro-actuators, wherein the in-plane translations of the micro-actuators are converted to the out-of-plane translations of the micromirrors using the micro-converters, The micromirrors, the micro-actuators, and the micro-converters are fabricated by microfabrication technology on the same substrate in order to reduce the volume of the automatic focusing system. The automatic focusing system of the present invention can have more robust and reliable automatic focusing function by using a plurality of micromirrors.

The automatic focusing system further comprises an image processor in communication with the image sensor and the control circuit, wherein the image processor uses an algorithm to compare the image quality of the image data from the image sensor with focus criteria and generates a feedback signal for the control circuitry to adjust the out-of-plane translations of the micromirrors. The out-of-plane translations of the micromirrors are adjusted by the control circuitry controlling the in-plane translation of the micro-actuator by using the feedback signal from the image processor

The fabrication thickness of each micromirror is less than 100 μm. The fabrication thickness of each micro-actuator is less than 100 μm. The fabrication thickness of each micro-converter is less than 100 μm. The micro-actuators are actuated by electrostatic force. The micro-actuator is a comb-drive.

Each micromirror can be rotatably connected by at least one micro-converter. Instead of being connected rigidly to at least one micro-converter, each micromirror can be supported by at least one micro-converter. Each micro-actuator is rotatably connected by at least one micro-converter. In addition to having a translation, each micromirror can be configured to have a rotation about at least one axis lying on the in-plane by changing the in-plane translations of the micro-actuators.

Each micromirror is configured to translate at least 100 μm. Each micromirror is configured to translate between 50 μm and 1,000 μm.

The automatic focusing system further comprises a beam splitter positioned between the lens unit and the MEMS unit. Instead of using the beam splitter, the MEMS unit can be positioned obliquely with respect to an optical axis of the lens unit in the automatic focusing system such that the image received from the lens unit is focused on the image sensor.

Each micro-converter comprises at least one beam and at least one hinge.

Each micro-converter comprises a first beam and a second beam. A first end of the first beam is rotatably connected to the micro-actuator and a second end of the first beam is rotatably connected to the micromirror. A first end of the second beam is rotatably connected to the micromirror and a second end of the second beam is rotatably connected to the substrate. In this configuration, the micro-converter can make the micromirror have in-plane translation as well as out-of-plane translation.

To avoid the in-plane translation of the micromirror, each micro-converter comprises a first beam and a second beam. A first end of the first beam is rotatably connected to the micro-actuator and a second end of the first beam is rotatably connected to a first end of the second beam. A second end of the second beam is rotatably connected to the substrate. In this configuration, the micromirror is supported by a pivot point connecting the second end of the first beam and the first end of the second beam. Each micromirror has at least one flexible member connecting the micromirror and the substrate and providing restoring force to the micromirror.

The micromirrors are a Micromirror Array Lens.

The focus (or image) can be shifted by the out-of-plane translations of the micromirrors. The micromirrors are configured to be tilted to compensate focus shift with respect to the image sensor. Also, the Micromirror Array Lens can change its optical axis to compensate focus shift with respect to the image sensor. Alternatively, the image processor can compensate focus shift with respect to the image sensor using a compensation algorithm.

An automatic focusing system as another embodiment of the present invention using an MEMS unit comprises a lens unit, an image sensor and an MEMS unit. The MEMS comprises a micromirror having reflective surfaces and configured to have out-of-plane translation, at least one micro-actuators configured to have in-plane translation, at least one micro-converter configured to convert the in-plane translation of the micro-actuator to the out-of-plane translation of the micromirror, and a substrate having a control circuitry and supporting the micromirror, the micro-actuator, and the micro-converter. The MEMS unit is positioned between the lens unit and the image sensor and configured to automatically focus an image received from the lens unit to the image sensor by adjusting the out-of-plane translation of the micromirror. The out-of-plane translation of the micromirror are adjusted by the control circuitry controlling the in-plane translation of the micro-actuator, wherein the in-plane translation of the micro-actuator are converted to the out-of-plane translation of the micromirror using the micro-converter, The micromirror, the micro-actuator, and the micro-converter are fabricated by microfabrication technology on the same substrate in order to reduce the volume of the automatic focusing system. The automatic focusing system further comprises an image processor in communication with the image sensor and the control circuit, wherein the image processor uses an algorithm to compare the image quality of the image data from the image sensor with focus criteria and generates a feedback signal for the control circuitry to adjust the out-of-plane translation of the micromirror. The out-of-plane translation of the micromirror is adjusted by the control circuitry controlling the in-plane translation of the micro-actuator by using the feedback signal from the image processor. The micromirror is configured to translate at least 100 μm. The micromirror is configured to translate between 50 μm and 1,000 μm. The micromirror is configured to be tilted to compensate focus shift with respect to the image sensor. Also, the image processor can compensate focus shift with respect to the image sensor using a compensation algorithm.

An automatic focusing system as another embodiment of the present invention using an MEMS unit comprises a lens unit, an image sensor, and an MEMS unit. The MEMS unit comprises a plurality of micromirrors having reflective surfaces and configured to have out-of-plane translations, a plurality of actuation units configured to move the micromirrors, and a substrate having a control circuitry and supporting the micromirrors and the micro-actuators. The MEMS unit is positioned between the lens unit and the image sensor and configured to automatically focus an image received from the lens unit to the image sensor by adjusting the out-of-plane translations of the micromirrors. The out-of-plane translations of the micromirrors are adjusted by the control circuitry controlling the actuation units. The micromirrors and the actuation units are fabricated by microfabrication technology on the same substrate in order to reduce the volume of the automatic focusing system. The automatic focusing system further comprises an image processor in communication with the image sensor and the control circuit, wherein the image processor uses an algorithm to compare the image quality of the image data from the image sensor with focus criteria and generates a feedback signal for the control circuitry to adjust the out-of-plane translations of the micromirrors. The out-of-plane translations of the micromirrors are adjusted by the control circuitry controlling the in-plane translations of the actuation units by using the feedback signal from the image processor. Each micromirror is configured to translate at least 100 μm. Each micromirror is configured to translate between 50 μm and 1,000 μm.

The micromirrors are a Micromirror Array Lens. The focus (or image) can be shifted by the out-of-plane translations of the micromirrors. The micromirrors are configured to be tilted to compensate focus shift with respect to the image sensor. The Micromirror Array Lens changes its optical axis to compensate focus shift with respect to the image sensor. The image processor compensates focus shift with respect to the image sensor by using a compensation algorithm.

Although the present invention is brief summarized herein, the full understanding of the invention can be obtained by the following drawings, detailed description, and appended claims.

### DESCRIPTION OF THE FIGURES

These and other features, aspects, and advantages of the present invention will become better understood with reference to the accompanying drawings, wherein:

FIG. 1 shows a conventional automatic focusing system using a mirror translation;

FIG. 2 is a schematic diagram for a compact automatic focusing system using an MEMS unit;

FIG. 3 is a schematic diagram for one embodiment of an automatic focusing system with an obliquely positioned MEMS unit;

FIG. 4 is a schematic diagram of a side view of one embodiment of an MEMS unit;

FIG. 5 is a schematic diagram of a side view of another embodiment of an MEMS unit;

FIGS. 6A and 6B are schematic diagrams showing how auto focusing is performed;

FIG. 7 is a schematic diagram showing how auto focusing is performed when object distance is changed;

FIG. 8 is a schematic diagram of an auto focusing system performing auto focusing and focus shift compensation;

FIG. 9A is a schematic diagram of a side view of one exemplary MEMS unit using a plurality of micromirrors;

FIGS. 9B and 9C are schematic diagrams of top views of exemplary arrangements of the micromirrors, micro-actuators, and micro-converters;

FIG. 10 is a schematic diagram of another exemplary MEMS unit using a plurality of micromirrors;

FIG. 11A is a schematic diagram showing how MEMS units are used for auto focusing;

FIG. 11B is a schematic diagram showing how a Micromirror Array Lens are used for auto focusing;

FIG. 11C is a schematic diagram showing how a Micromirror Array Lens are used for auto focusing and focus shift compensation.

### DETAILED DESCRIPTION OF THE INVENTION

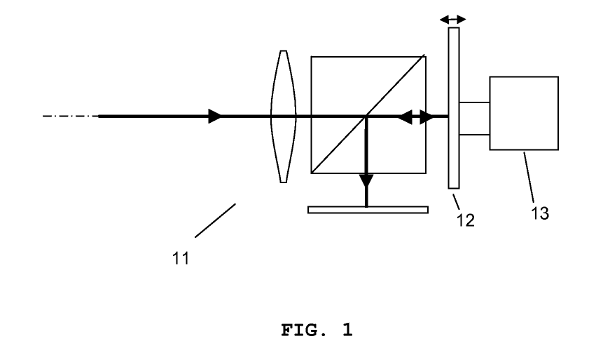

FIG. 1 shows a conventional automatic focusing system using a mirror translation. The conventional automatic focusing system 11 uses a mirror 12 configured to be actuated by a macroscopic actuator 13. This automatic focusing system can have many problem including bulky size, large power consumption, slow focusing time, and eventually decrease in portability.

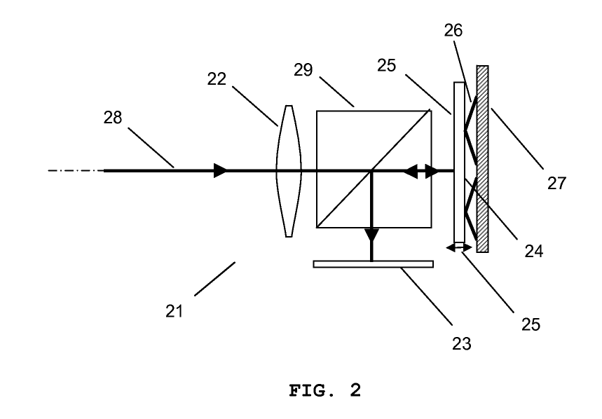

FIG. 2 is a schematic diagram for a compact automatic focusing system of the present invention using an MEMS unit. The compact automatic focusing system 21 comprises a lens unit 22, an image sensor 23, and an MEMS unit. Although the lens unit 22 is illustrated as a single objective lens, those skilled in the art will understand that the lens unit 22 may comprise a plurality of lenses depending upon a particular application. The MEMS unit comprises at least one micromirror 24 having a reflective surface and configured to have out-of-plane translation 25, at least one actuation unit 26 configured to provide the micromirror 24 with out-of-plane translation 25, and a substrate 27 having a control circuitry (not shown) and supporting the micromirror 24 and the actuation unit 26. The micromirror 24 and the actuation unit 26 are fabricated by microfabrication technology on the same substrate 27 in order to reduce the volume of the automatic focusing system 21. Because the out-of-plane dimension of the micromirror 24 and the actuation unit 26 is typically in order of several micrometers, the volume of the MEMS unit is negligible. The micromirror 24 should reflect incident light 28 into an image sensor 23. Therefore, the automatic focusing system 21 requires a beam splitter 29. Because the beam splitter 29 wastes 75% of the incident light 28, it is desirable to position the micromirror 25 obliquely with respect to an optical axis of the lens unit 22 instead of using the beam splitter 29.

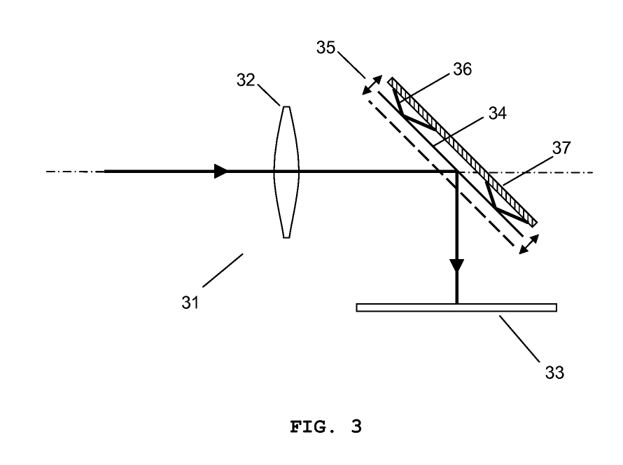

FIG. 3 is a schematic diagram for one embodiment of an automatic focusing system with an obliquely positioned MEMS unit. The automatic focusing system 31 comprises a lens unit 32, an image sensor 33, and an MEMS unit. The MEMS unit comprises at least one micromirror 34 having a reflective surface and configured to have out-of-plane translation 35, at least one actuation unit 36 configured to provide the micromirror 34 with out-of-plane translation 35, and a substrate 37 having a control circuitry (not shown) and supporting the micromirror 34 and the actuation unit 36. The MEMS unit is obliquely positioned between the lens unit 32 and the image sensor 33 and configured to automatically focus an image received from the lens unit 32 to the image sensor 33 by adjusting the out-of-plane translation 35 of the micromirror 34 using the actuation unit 36.

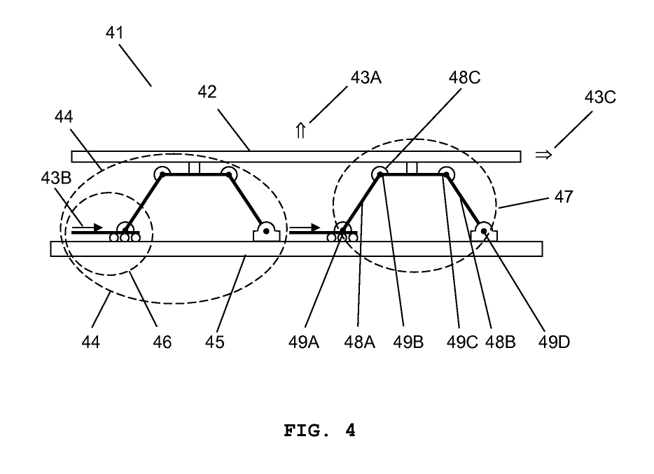

FIG. 4 is a schematic diagram of a side view of one embodiment of an MEMS unit configured to generate the large out-of-plane translation of a micromirror. The conventional MEMS devices are capable of providing a limited range of out-of-plane translation (typically only several micrometers), while the in-plane translation can be more than several millimeters. To provide the large out-of-plane translation of the micromirror, the present invention uses micro-converters configured to convert large in-plane translation to large out-of-plane translation. The MEMS unit 41 of the present invention comprises at least one micromirror 42 having a reflective surface and configured to have out-of-plane translation 43A, at least one actuation unit 44 configured to provide the micromirror 42 with out-of-plane translation 43A, and a substrate 45 having a control circuitry (not shown) and supporting the micromirror 42 and the actuation unit 44. In order to increase the range of the out-of-plane translation 43A of the micromirror 42, the actuation unit 44 of the MEMS unit 41 of the present invention preferably comprises at least one micro-actuator 46 configured to have in-plane translation 43B and at least one micro-converter 47 configured to convert the in-plane translation 43B of the micro-actuator 46 to the out-of-plane translation 43A of the micromirror 42. Since the micro-actuator 46 can be fabricated to have large in-plane translation 43B using conventional MEMS technologies (e.g. comb-drive device), the micromirror 42 of the present invention can have large out-of-plan translation 43A. The out-of-plane translation 43A of the micromirror 42 is adjusted by the control circuitry controlling the in-plane translation 43B of the micro-actuator 46. The micromirror 42, the micro-actuator 46, and the micro-converter 47 are fabricated by microfabrication technology on the same substrate 45 in order to reduce the volume of the MEMS unit 41.

The micro-converter 47 comprises at least one beam 48A, 48B and at least one hinge 48C to convert the in-plane translation 43B of the micro-actuator 46 to the out-of-translation 43A of the micromirror 42.

In one embodiment of the present invention, each micro-converter 47 comprises a first beam 48A and a second beam 48B. A first end 49A of the first beam 48A is rotatably connected to the micro-actuator 46 and a second end 49B of the first beam 48A is rotatably connected to the micromirror 42. A first end 49C of the second beam 48B is rotatably connected to the micromirror 42 and a second end 49D of the second beam 48B is rotatably connected to the substrate 45. In this configuration, the micro-converter 47 can make the micromirror 42 have in-plane translation 43C as well as out-of-plane translation 43A.

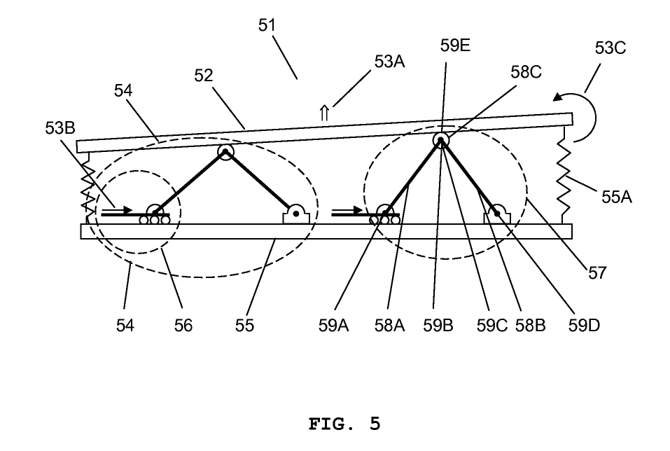

The MEMS unit can be configured to avoid the unnecessary in-plane translation 43C of the micromirror 42 as shown in FIG. 5. FIG. 5 is a schematic diagram of a side view of another embodiment of an MEMS unit. The MEMS unit 51 of the present invention comprises at least one micromirror 52 having a reflective surface and configured to have out-of-plane translation 53A, at least one actuation unit 54 configured to provide the micromirror 52 with out-of-plane translation 53A, and a substrate 55 having a control circuitry (not shown) and supporting the micromirror 52 and the actuation unit 54. In order to increase the range of the out-of-plane translation 53A of the micromirror 52, the actuation unit 54 of the MEMS unit 51 of the present invention preferably comprises at least one micro-actuator 56 configured to have in-plane translation 53B and at least one micro-converter 57 configured to convert the in-plane translation 53B of the micro-actuator 56 to the out-of-plane translation 53A of the micromirror 52. Since the micro-actuator 56 can be fabricated to have large in-plane translation 53B using conventional MEMS technologies (e.g. comb-drive device), the micromirror 52 of the present invention can have large out-of-plan translation 53A. The out-of-plane translation 53A of the micromirror 52 is adjusted by the control circuitry controlling the in-plane translation 53B of the micro-actuator 56. The micromirror 52, the micro-actuator 56, and the micro-converter 57 are fabricated by microfabrication technology on the same substrate 55 in order to reduce the volume of the MEMS unit 51.

The micro-converter 57 comprises at least one beam 58A, 58B and at least one hinge 58C to convert the in-plane translation 53B of the micro-actuator 56 to the out-of-translation 53A of the micromirror 52.

Each micro-converter 57 comprises a first beam 58A and a second beam 58B. A first end 59A of the first beam 58A is rotatably connected to the micro-actuator 56 and a second end 59B of the first beam 58A is rotatably connected to a first end 59C of the second beam 58B. A second end 59D of the second beam 58B is rotatably connected to the substrate 55. In this configuration, the micromirror 52 is supported by a pivot point 59E connecting the second end 59B of the first beam 58A and the first end 59C of the second beam 58B. Each micromirror 52 has at least one flexible member 55A connecting the micromirror 52 and the substrate 55 and providing restoring force to the micromirror 52. The restoring force of the flexible member 55A makes the tops of the micro-converters 57 be in contact with the bottom of the micromirror 52. The MEMS unit 51 removes the unnecessary translation of the micromirror 52.

FIG. 5 also shows that the MEMS unit is capable of providing the micromirror with rotation as well as large out-of-plane translation. In-plane translations 53B of a plurality of micro-actuators 56 can make the micromirror 52 have both rotation and translation. The micro-converters 57 convert the in-plane translations 53B of the micro-actuators 56 to the rotation 53C and out-of-plane translation 53A of the micromirror 52. The micro-micromirror 52 is configured to have a plurality of rotations 53C and out-of-plane translations 53A by adjusting an amount of the in-plane translation 53B of each micro-actuator 56.

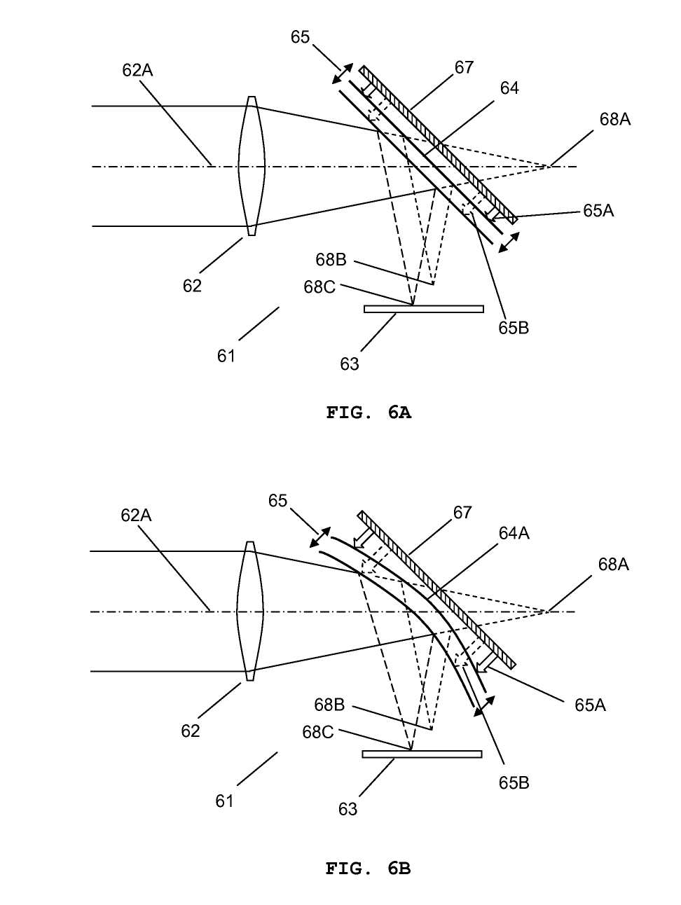

FIGS. 6A and 6B are schematic diagrams showing how the auto focusing system of FIG. 3 performs auto focusing. FIG. 6A is a schematic diagram of an auto focusing system 61 using a micromirror 64, wherein the out-of-plane translation 65 of the micromirror 64 changes the focal plane of the auto focusing system 61. The lens unit 62 makes its focus at a focal point 68A without a micromirror. In order to provide auto focusing, a micromirror 64 is disposed obliquely with respect to an optical axis 62A between the lens unit 62 and the image sensor 63. The micromirror 64 is configured to have a plurality of displacements from the substrate 67 in the out-of-plane direction. When the micromirror 64 is located at a position 65A, the focus 68B is out of the plane of the image sensor 63. To perform auto focusing, the micromirror 64 is moved to another position 65B in the out-of-plane direction. Then, the micromirror 64 and the lens unit 62 make a focus 68C on another focal plane. The position of the focal plane can be adjusted to be on the plane of the image sensor 63 by adjusting the out-of-plane translation 65 of the micromirror 64. When the focal plane is on the plane of the image sensor 63, auto focusing is accomplished.

In order to provide focusing status, the auto focusing system 61 can further comprise an image processor (not shown) in communication with the image sensor 63 and the control circuit. The image processor uses an algorithm to compare the image quality of the image data from the image sensor 63 with focus criteria and generates a feedback signal for the control circuitry to adjust the out-of-plane translation 65 of the micromirror 64.

The micromirror 64 is not necessarily aligned with 45 degree to an image side optical axis 62A. The angle between micromirror 64 and the image side optical axis 62A can be varied if the geometry permits.

FIG. 6B is a schematic diagram of an auto focusing system using a curved micromirror 64A. Similarly to the micromirror 64 in FIG. 6A, the position of the focal plane can be adjusted to be on the plane of the image sensor 63 by adjusting the out-of-plane translation of the curved micromirror 64A. When the focal plane is on the plane of the image sensor 63, auto focusing is accomplished.

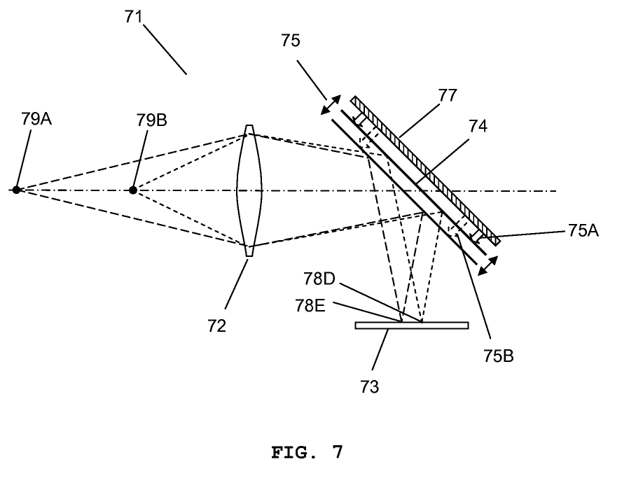

FIG. 7 is a schematic diagram showing how auto focusing is performed when object distance is changed. When an object is located at a position 79A, the micromirror 74 is required to have a certain position 75A in the out-of-plane direction to make a focus 78D on the plane of the image sensor 73. When the object moves from the point 79A to other position 79B, the micromirror 74 is controlled to have out-of-plane translation 75 from one position 75A to another position 75B so that the focus 78E remains on the plane of the image sensor 73. Without changing the focal length of the lens unit 72, the auto focusing system 71 can make its focus on the plane of the image sensor 73.

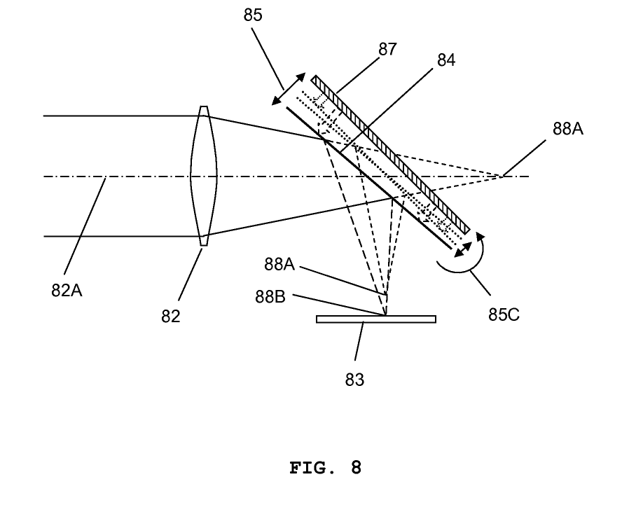

The focus (or image) can be shifted when the out-of-plane translations of the micromirror is used for auto focusing as shown in FIGS. 6 and 7. As an example, the auto focusing system in FIG. 7 is considered. In the auto focusing system of FIG. 7, the focus is shifted from 78D to 78E due to auto focusing. To compensate this focus shift, the micromirror 74 is configured to have rotation as well as out-of-plane translation. FIG. 8 is a schematic diagram of an auto focusing system performing auto focusing and focus shift compensation. The lens unit 82 makes its focus 88A without a micromirror. In order to provide auto focusing and focus shift compensation, a micromirror 84 is disposed obliquely with respect to an optical axis 82A between the lens unit 82 and an image sensor 83. The micromirror 84 is configured to have a plurality of displacements from the substrate 87 in the out-of-plane direction 85 and a plurality of rotations 85C. The micromirror 84 has out-of-plane translation 85 to make its focus on the plane of the image sensor 83 and has rotation 85C to compensate focus shift. In this case, the focus is changed from 88A to 88B. The MEMS unit of the present invention can provide the micromirror 84 with both out-of-plane translation 85 and rotation 85C as shown in FIG. 5.

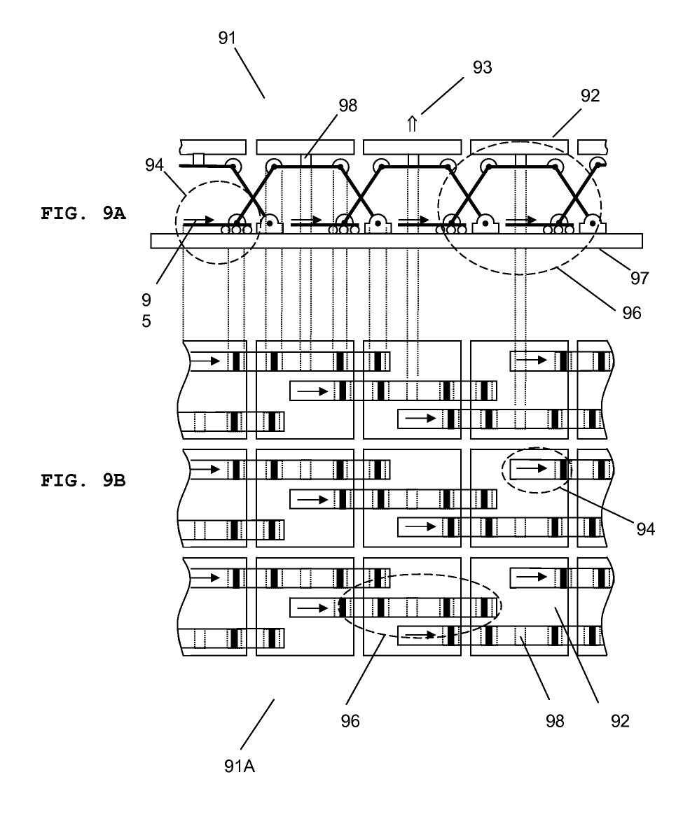

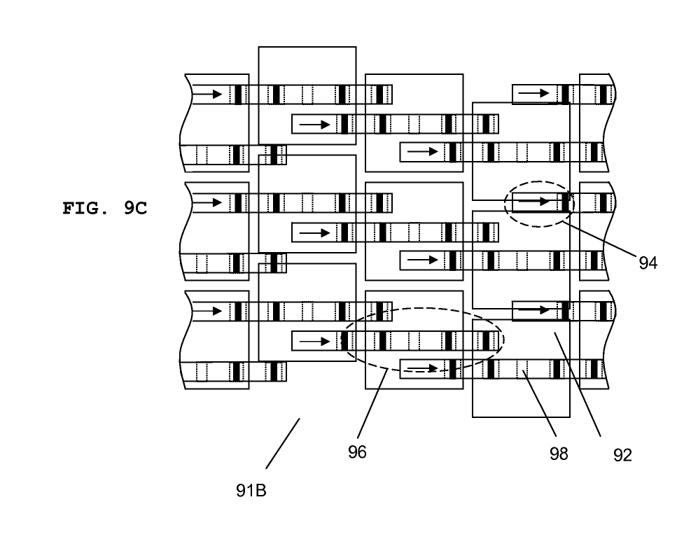

When an automatic focusing system uses a single mirror having a large area size, distortion and twisting problems of the mirror can occur, which causes aberration. The MEMS unit of the present invention can provide more robust and reliable automatic focusing system by using a plurality of micromirrors, wherein each micromirror is configured to provide large out-of-plane translation. Each micromirror and its actuation unit can have a configuration shown in FIG. 4 or FIG. 5. FIG. 9A is a schematic diagram of a side view of one exemplary MEMS unit using a plurality of micromirrors. The MEMS unit 91 comprises a plurality of micromirrors 92 having reflective surfaces and configured to have out-of-plane translations 93, a plurality of micro-actuators 94 configured to have in-plane translations 95, a plurality of micro-converters 96 configured to convert the in-plane translations 95 of the micro-actuators 94 to the out-of-plane translations 93 of the micromirrors 92, and a substrate 97 having a control circuitry and supporting the micromirrors 92, the micro-actuators 94, and micro-converters 96. The micromirrors 92, the micro-actuators 94, and the micro-converters 96 are fabricated by microfabrication technology on the same substrate 97 in order to reduce the volume of the automatic focusing system. Although the MEMS unit 91 comprising a plurality of micromirrors 92 is illustrated by using a plurality of MEMS units 41 of FIG. 4, those skilled in the art will understand that the MEMS unit 91 using a plurality micromirrors 92 can be made with any combination of micro-actuators and micro-converters including that of the FIG. 5 depending upon a particular application. The micro-actuators 94 and the micro-converters 96 that make micromirrors 92 move are disposed over the substrate 97 such that the motion of each micromirror does not interfere with the motions of other micromirrors. FIGS. 9B and 9C show schematic diagrams of top views of exemplary arrangements of the micromirrors 92, micro-actuators 94, and micro-converters 96. The point or area 98 on each micromirror 92 can be a connecting pivot point or area of FIG. 4 or a contacting pivot point or area of FIG. 5 between the micromirror 92 and the micro-converter 96.

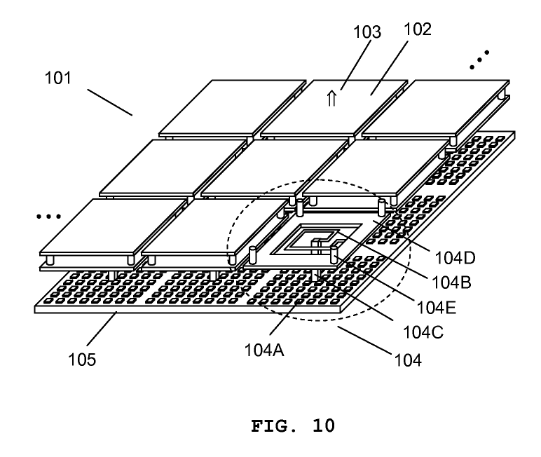

FIG. 10 is a schematic diagram of another exemplary MEMS unit using a plurality of micromirrors. The MEMS unit 101 comprises a plurality of micromirrors 102 having reflective surfaces and configured to have out-of-plane translations 103, a plurality of actuation units 104 configured to provide the micromirrors 102 with out-of-plane translations 103, and a substrate 105 having a control circuitry (not shown) and supporting the micromirrors 102 and the actuation units 104. The micromirrors 102 and the actuation units 104 are fabricated by microfabrication technology on the same substrate 105 in order to reduce the volume of the automatic focusing system. Each actuation unit 104 is configured to provide a corresponding micromirror 102 with out-of-plane translation 103. Each actuation unit 104 comprises a plurality of segmented electrodes 104A disposed on the substrate surface 105 and electronically coupled to the control circuitry for activating the segmented electrodes 104A selectively, at least one flexible structure 104B for connecting the micromirror 102 and the substrate 105 and providing restoring force to the micromirror 102, and at least one pillar structure 104C for supporting the flexible structure 104B and providing connection between the substrate 105 and the flexible structure 104B. The actuation unit 104 further comprises at least one top electrode plate 104D disposed underneath the micromirror 102. The activated segment electrodes 104A of each actuation unit 104 attract the micromirror 102 in the out-of-plane direction 103. The top electrode plate 104D increases the electrostatic force induced between the segmented electrodes 104A and the top electrode plate 104D by reducing the electrostatic gap between the electrodes. Also, the structural deformation of the micromirror 102 is reduced by connecting the micromirror 102 to the top electrode plate 104D using at least one top electrode post 104E.

The actuation unit 104 of the present invention can provide the micromirrors 102 with rotation as well. The rotation and translation of each micromirror 102 is controlled by a selected set of activated segmented electrodes 104A. The MEMS units 91A, 91B, and 101 of the present invention provide robust and reliable auto focusing systems by using a plurality of micromirrors, wherein each micromirror is configured to provide large out-of-plane translation.

The micromirrors of FIGS. 9B, 9C, and 10 are a Micromirror Array Lens forming at least one optical surface profile. The optical surface profile of the Micromirror Array Lens can be fixed or varied during auto focusing.

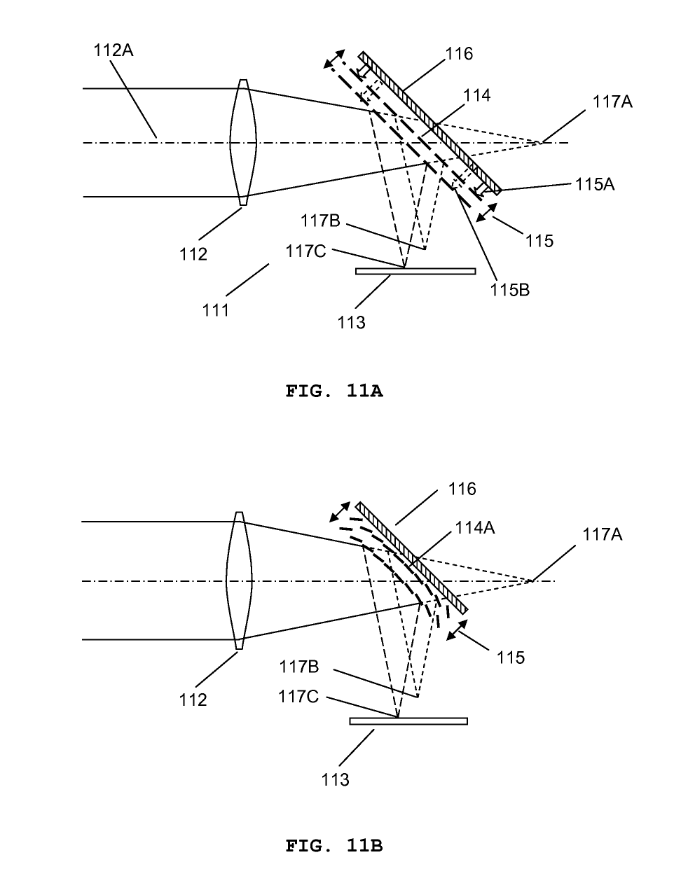

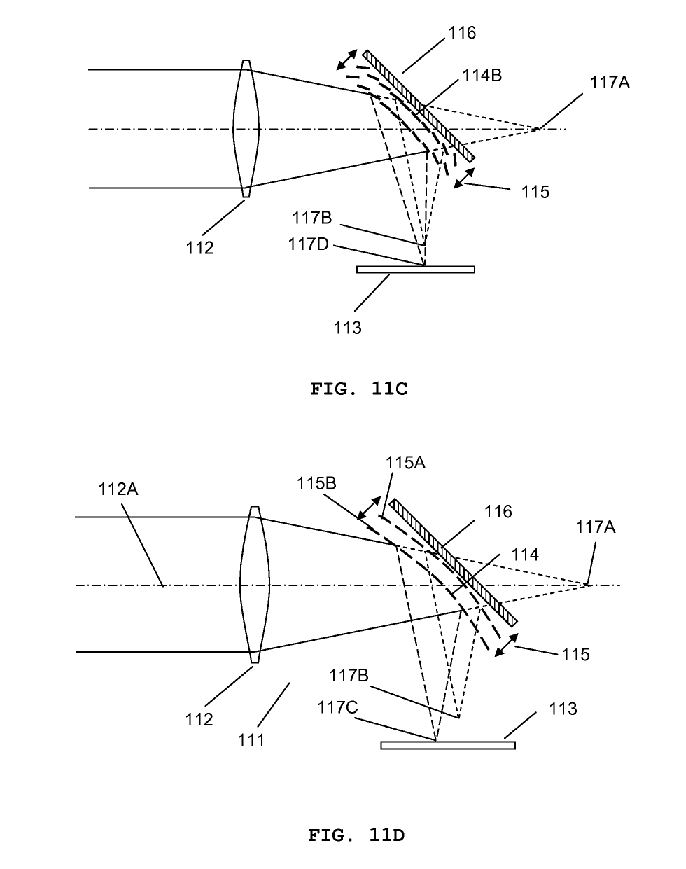

FIG. 11A shows how MEMS units in FIGS. 9B, 9C, and 10 are used for auto focusing. The automatic focusing system 111 comprises a lens unit 112, an image sensor 113, and an MEMS unit. The MEMS unit comprises a plurality of micromirrors 114 having reflective surfaces and configured to have out-of-plane translations 115, a plurality of micro-actuators (not shown) configured to have in-plane translations, a plurality of micro-converters (not shown) configured to convert the in-plane translations of the micro-actuators to the out-of-plane translations 115 of the micromirrors 114, and a substrate 116 having a control circuitry (not shown) and supporting the micromirrors 114, the micro-actuators, and micro-converters. The MEMS unit is positioned between the lens unit 112 and the image sensor 113 and configured to automatically focus an image received from the lens unit 112 to the image sensor 113 by adjusting the out-of-plane translations 115 of the micromirrors 114. The out-of-plane translations 115 of the micromirrors 114 are adjusted by the control circuit controlling the in-plane translations of the micro-actuators, wherein the in-plane translations of the micro-actuators are converted to the out-of-plane translations of the micromirrors using the micro-converters. The micromirrors 114, the micro-actuators, and the micro-converters are fabricated by microfabrication technology on the same substrate 116 in order to reduce the volume of the automatic focusing system 111.

The out-of-plane translations 115 of the micromirrors 114 change the focal plane of the auto focusing system 111. The lens unit 112 makes its focus at a focal point 117A without a micromirror. In order to provide auto focusing, an array of the micromirrors 114 are disposed obliquely with respect to an optical axis 112A between the lens unit 112 and the image sensor 113. Each micromirror 114 is configured to have a plurality of displacements from the substrate 116 in the out-of-plane direction. When the array of the micromirrors 114 is located at a position 115A, the focus 117B is out of the plane of the image sensor 113. To perform auto focusing, the array of the micromirrors 114 is moved to another position 115B in the out-of-plane direction 115. Then, the array of the micromirrors 114 and the lens unit 112 make a focus 117C on another focal plane. The position of the focal plane can be adjusted to be on the plane of the image sensor 113 by adjusting the out-of-plane translation of the array of the micromirror 114. When the focal plane is on the plane of the image sensor 113, auto focusing is accomplished.

In order to provide focusing status, the auto focusing system 111 can further comprise an image processor (not shown) in communication with the image sensor 113 and the control circuit. The image processor uses an algorithm to compare the image quality of the image data from the image sensor 113 with focus criteria and generates a feedback signal for the control circuitry to adjust the out-of-plane translations 115 of the micromirrors 114.

The array of the micromirrors 114 is not necessarily aligned with 45 degree to an image side optical axis 112A. The angle between the array of the micromirrors 114 and the image side optical axis 112A can be varied if the geometry permits.

FIG. 11B is a schematic diagram showing how a Micromirror Array Lens 114A are used for auto focusing. Similarly to the array of the micromirrors 114 in FIG. 11A, the position of the focal plane can be adjusted to be on the plane of the image sensor 113 by adjusting the out-of-plane translation 115 of the Micromirror Array Lens 114A. When the focal plane is on the plane of the image sensor 113, auto focusing is accomplished.

The focus can be shifted when the out-of-plane translation of the micromirror is used for auto focusing as shown in FIGS. 11A and 11B. The Micromirror Array Lens can compensate focus shift by changing its optical axis. FIG. 11C is a schematic diagram showing how a Micromirror Array Lens are used for auto focusing and focus shift compensation. Since the Micromirror Array Lens itself has an ability to change its optical axis, the auto focusing system with the Micromirror Array Lens 114B can change its focal length by out-of-plane translation 115 of the Micromirror Array Lens 114B and compensate focus shift by the optical axis change of the Micromirror Array Lens 114B. Without focus shift compensation, the Micromirror Array Lens 114B makes its focus at the position 117C. Using the optical axis change of the Micromirror Array Lens 114B, the Micromirror Array Lens 114B makes its focus at the position 117D, wherein both auto focusing and focus shift compensation are achieved simultaneously.

FIG. 11D shows how MEMS units in FIGS. 9B, 9C, and 10 and curved surface mirror in FIG. 6B are used for auto focusing. The automatic focusing system 111 comprises a lens unit 112, an image sensor 113, and an MEMS unit. The MEMS unit comprises a plurality of micromirrors 114 having curved reflective surfaces and configured to have out-of-plane translations 115, a plurality of micro-actuators (not shown) configured to have in-plane translations, a plurality of micro-converters (not shown) configured to convert the in-plane translations of the micro-actuators to the out-of-plane translations 115 of the micromirrors 114, and a substrate 116 having a control circuitry (not shown) and supporting the micromirrors 114, the micro-actuators, and micro-converters. The MEMS unit is positioned between the lens unit 112 and the image sensor 113 and configured to automatically focus an image received from the lens unit 112 to the image sensor 113 by adjusting the out-of-plane translations 115 of the micromirrors 114. The out-of-plane translations 115 of the micromirrors 114 are adjusted by the control circuit controlling the in-plane translations of the micro-actuators, wherein the in-plane translations of the micro-actuators are converted to the out-of-plane translations of the micromirrors using the micro-converters. The micromirrors 114, the micro-actuators, and the micro-converters are fabricated by microfabrication technology on the same substrate 116 in order to reduce the volume of the automatic focusing system 111.

The out-of-plane translations 115 of the micromirrors 114 change the focal plane of the auto focusing system 111. The lens unit 112 makes its focus at a focal point 117A without a micromirror. In order to provide auto focusing, an array of the micromirrors 114 are disposed obliquely with respect to an optical axis 112A between the lens unit 112 and the image sensor 113. Each micromirror 114 is configured to have a plurality of displacements from the substrate 116 in the out-of-plane direction. When the array of the micromirrors 114 is located at a position 115A, the focus 117B is out of the plane of the image sensor 113. To perform auto focusing, the array of the micromirrors 114 is moved to another position 115B in the out-of-plane direction 115. Then, the array of the micromirrors 114 and the lens unit 112 make a focus 117C on another focal plane. The position of the focal plane can be adjusted to be on the plane of the image sensor 113 by adjusting the out-of-plane translation of the array of the micromirror 114 other than by changing the surface profile of the array of the micromirrors 114. When the focal plane is on the plane of the image sensor 113, auto focusing is accomplished.

In order to provide focusing status, the auto focusing system 111 can further comprise an image processor (not shown) in communication with the image sensor 113 and the control circuit. The image processor uses an algorithm to compare the image quality of the image data from the image sensor 113 with focus criteria and generates a feedback signal for the control circuitry to adjust the out-of-plane translations 115 of the micromirrors 114.

The array of the micromirrors 114 is not necessarily aligned with 45 degree to an image side optical axis 112A. The angle between the array of the micromirrors 114 and the image side optical axis 112A can be varied if the geometry permits.

The general principle and methods for making the Micromirror Array Lens are disclosed in U.S. Pat. No. 6,970,284 issued Nov. 29, 2005 to Kim, U.S. Pat. No. 7,031,046 issued Apr. 18, 2006 to Kim, U.S. Pat. No. 6,934,072 issued Aug. 23, 2005 to Kim, U.S. Pat. No. 6,934,073 issued Aug. 23, 2005 to Kim, U.S. Pat. No. 7,161,729 issued Jan. 09, 2007, U.S. Pat. No. 6,999,226 issued Feb. 14, 2006 to Kim, U.S. Pat. No. 7,095,548 issued Aug. 22, 2006 to Cho, U.S. patent applicaton Ser. No. 10/893,039 filed Jul. 16, 2004, U.S. patent application Ser. No. 10/983,353 filed Nov. 8, 2004, U.S. patent applicaton Ser. No. 11/076,616 filed Mar. 10, 2005, and U.S. patent applicaton Ser. No. 11/426,565 filed Jun. 26, 2006, all of which are incorporated herein by references.

Also the general properties of the Micromirror Array Lens are disclosed in U.S. Pat. No. 7,057,826 issued Jun. 6, 2006 to Cho, U.S. Pat. No. 7,173,653 issued Feb. 06, 2007, U.S. Pat. No. 7,215,882 issued May 8, 2007 to Cho, U.S. patent applicaton Ser. No. 10/979,568 filed Nov. 2, 2004, U.S. patent applicaton Ser. No. 11/218,814 filed Sep. 2, 2005, U.S. patent application Ser. No. 11/359,121 filed Feb. 21, 2006, U.S. patent applicaton Ser. No. 11/382,273 filed May 9, 2006, and U.S. patent applicaton Ser. No. 11/429,034 filed May 5, 2006, and its application are disclosed in U.S. Pat. No. 7,077,523 issued Jul. 18, 2006 to Seo, U.S. Pat. No. 7,068,416 issued Jun. 27, 2006 to Gim, U.S. patent applicaton Ser. No. 10/914,474 filed Aug. 9, 2004, U.S. patent application Ser. No. 10/934,133 filed Sep. 3, 2004, U.S. patent applicaton Ser. No. 10/979,619 filed Nov. 2, 2004, U.S. patent application Ser. No. 10/979,624 filed Nov. 2, 2004, U.S. patent applicaton Ser. No. 11/076,688 filed Mar. 10, 2005, U.S. patent applicaton Ser. No. 11/208,114 filed Aug. 19, 2005, U.S. patent application Ser. No. 11/208,115 filed Aug. 19, 2005, U.S. patent applicaton Ser. No. 11/382,707 filed May 11, 2006, U.S. patent application Ser. No. 11/419,480 filed May 19, 2006, U.S. patent applicaton Ser. No. 11/423,333 filed Jun. 9, 2006, and U.S. patent applicaton Ser. No. 11/933,105 filed Oct. 31, 2007, all of which are incorporated herein by references.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. An automatic focusing system comprising:
a lens unit;
an image sensor; and
a Micro-Electro Mechanical System (MEMS) unit comprising a plurality of micromirrors having reflective surfaces and configured to have out-of-plane translations, a plurality of micro-actuators configured to have in-plane translations, a plurality of micro-converters configured to convert the in-plane translations of the micro-actuators to the out-of-plane translations of the micromirrors, and a substrate having a control circuitry and supporting the micromirrors, the micro-actuators, and micro-converters,
wherein the MEMS unit is positioned between the lens unit and the image sensor and configured to automatically focus an image received from the lens unit to the image sensor by adjusting the out-of-plane translations of the micromirrors, wherein the out-of-plane translations of the micromirrors are adjusted by the control circuitry controlling the in-plane translations of the micro-actuators, wherein the in-plane translations of the micro-actuators are converted to the out-of-plane translations of the micromirrors using the micro-converters, wherein the micromirrors, the micro-actuators, and the micro-converters are fabricated by microfabrication technology on the same substrate in order to reduce the volume of the automatic focusing system.

2. The automatic focusing system of claim 1, further comprising an image processor in communication with the image sensor and the control circuit, wherein the image processor uses an algorithm to compare image quality of an image data from the image sensor with focus criteria and generates a feedback signal for the control circuitry to adjust the out-of-plane translations of the micromirrors.

3. The automatic focusing system of claim 1, wherein fabrication thickness of each micromirror is less than 100 μm.

4. The automatic focusing system of claim 1, wherein fabrication thickness of each micro-actuator is less than 100 μm.

5. The automatic focusing system of claim 1, wherein fabrication thickness of each micro-converter is less than 100 μm.

6. The automatic focusing system of claim 1, wherein the micro-actuators are actuated by electrostatic force.

7. The automatic focusing system of claim 1, wherein the micro-actuator is a comb-drive.

8. The automatic focusing system of claim 1, wherein each micromirror is rotatably connected by at least one micro-converter.

9. The automatic focusing system of claim 1, wherein each micromirror is supported by at least one micro-converter.

10. The automatic focusing system of claim 1, wherein each micro-actuator is rotatably connected by at least one micro-converter.

11. The automatic focusing system of claim 1, wherein each micromirror is configured to have rotation about at least one axis lying on the in-plane by changing the in-plane translations of the micro-actuators.

12. The automatic focusing system of claim 1, wherein each micromirror is configured to translate at least 100 μm.

13. The automatic focusing system of claim 1, wherein each micromirror is configured to translate between 50 μm and 1,000 μm.

14. The automatic focusing system of claim 1, further comprising a beam splitter positioned between the lens unit and the MEMS unit.

15. The automatic focusing system of claim 1, wherein the MEMS unit is positioned obliquely with respect to an optical axis of the lens unit such that the image received from the lens unit is focused on the image sensor.

16. The automatic focusing system of claim 1, wherein each micro-converter comprises at least one beam and at least one hinge.

17. The automatic focusing system of claim 1, wherein each micro-converter comprises a first beam and a second beam wherein a first end of the first beam is rotatably connected to the micro-actuator and a second end of the first beam is rotatably connected to the micromirror, wherein a first end of the second beam is rotatably connected to the micromirror and a second end of the second beam is rotatably connected to the substrate.

18. The automatic focusing system of claim 1, wherein each micro-converter comprises a first beam and a second beam wherein a first end of the first beam is rotatably connected to the micro-actuator and a second end of the first beam is rotatably connected to a first end of the second beam, wherein a second end of the second beam is rotatably connected to the substrate, wherein the micromirror is supported by a pivot point connecting the second end of the first beam and the first end of the second beam.

19. The automatic focusing system of claim 1, wherein each micromirror has at least one flexible member connecting the micromirror and the substrate and providing restoring force to the micromirror.

20. The automatic focusing system of claim 1, wherein the micromirrors are a Micromirror Array Lens.

21. The automatic focusing system of claim 1, wherein the micromirrors are configured to be tilted to compensate focus shift with respect to the image sensor.

22. The automatic focusing system of claim 20, wherein the Micromirror Array Lens changes its optical axis to compensate focus shift with respect to the image sensor.

23. The automatic focusing system of claim 2, wherein the image processor compensates focus shift with respect to the image sensor by using a compensation algorithm.

24. An automatic focusing system comprising:
a lens unit;
an image sensor;
an MEMS unit comprising at least one micromirror having reflective surfaces and configured to have out-of-plane translation, at least one micro-actuators configured to have in-plane translation, at least one micro-converter configured to convert the in-plane translation of the micro-actuator to the out-of-plane translation of the micromirror, and a substrate having a control circuitry and supporting the micromirror, the micro-actuator, and the micro-converter; and
an image processor in communication with the image sensor and the control circuit, wherein the MEMS unit is positioned between the lens unit and the image sensor and configured to automatically focus an image received from the lens unit to the image sensor by adjusting the out-of-plane translation of the micromirror, wherein the image processor uses an algorithm to compare image quality of an image data from the image sensor with focus criteria and generates a feedback signal for the control circuitry to adjust the out-of-plane translation of the micromirror, wherein the out-of-plane translation of the micromirror are adjusted by the control circuitry controlling the in-plane translation of the micro-actuator by using the feedback signal from the image processor, wherein the in-plane translation of the micro-actuator is converted to the out-of-plane translation of the micromirror using the micro-converter, wherein the micromirror, the micro-actuator, and the micro-converter are fabricated by microfabrication technology on the same substrate in order to reduce the volume of the automatic focusing system.

25. An automatic focusing system comprising:
a lens unit;
an image sensor;
an MEMS unit comprising a plurality of micromirrors having reflective surfaces and configured to have out-of-plane translations, a plurality of actuation units configured to move the micromirrors, and a substrate having a control circuitry and supporting the micromirrors and the actuation units; and
an image processor in communication with the image sensor and the control circuit, wherein the MEMS unit is positioned between the lens unit and the image sensor and configured to automatically focus an image received from the lens unit to the image sensor by adjusting the out-of-plane translations of the micromirrors, wherein the image processor uses an algorithm to compare image quality of an image data from the image sensor with focus criteria and generates a feedback signal for the control circuitry to adjust the out-of-plane translation of the micromirror, wherein the out-of-plane translations of the micromirrors are adjusted by the control circuitry controlling the actuation units by using the feedback signal from the image processor, wherein the micromirrors and the actuation units are fabricated by microfabrication technology on the same substrate in order to reduce the volume of the automatic focusing system.
